(19) United States
(12) Patent Application Publication
(10) Pub. No.: US 2022/0335403 A1
(43) Pub. Date: Oct. 20, 2022

(54) PRINTING SUBSTRATE, METHOD OF MANUFACTURE, METHOD OF USE, AND COMPUTER SYSTEM

(71) Applicant: PAYPER TECHNOLOGIES LIMITED, Manchester, (GB)

(72) Inventor: Thanasis GEORGIOU, MANCHESTER (GB)

(21) Appl. No.: 17/753,823

(22) PCT Filed: Sep. 16, 2020
(86) PCT No.: PCT/GB2020/052238

§ 371 Date: Mar. 16, 2022

(30) Foreign Application Priority Data
Sep. 16, 2019 (GB) 1913365.1

(51) Int. Cl. G06Q 20/20; B41M 5/28; B41M 3/00; C09D 11/52; C09D 11/037; C09D 11/101; C09D 11/03

(52) U.S. Cl. CPC G06Q 20/209; B41M 5/284; B41M 3/006; C09D 11/52; C09D 11/037; C09D 11/101; C09D 11/03; H04W 4/80

(57) ABSTRACT

A receipt roll for a receipt printer of a point of sale system, the receipt roll has a substrate for the printing of receipt information by the receipt printer, and at least one near field RF communicator carried by the substrate and configured to store a unique identifier for communicating via near field communications to a near Held communication device in near field range.

### TECHNICAL FIELD

The present disclosure relates to methods and apparatus which may employ near field RF communications, and more particularly to apparatus such as printing substrates which may incorporate near field RF communications functionality, and methods of manufacturing such substrates and methods for their use.

### BACKGROUND

Near field RF communication technologies such as RFID and NFC are becoming increasingly ubiquitous. Nearly every modern smartphone includes NFC communication capabilities, and is therefore able to operate as a reader of other near field RF communications devices. In addition, with the advent of contactless payment, such readers are also present in electronic point of sale systems (EPOS).

Near field RF communications requires an antenna of one near field RF communicator to be present within the alternating magnetic field (H field) generated by the antenna of another near field RF communicator by transmission of an RF signal (for example a 13.56 Mega Hertz signal) to enable the magnetic field (H field) of the RF signal to be inductively coupled between the communicators. The RF signal may be modulated to enable communication of control and/or other data. Ranges of up to several centimetres (generally a maximum of 1 metre) are common for near field RF communicators.

Near field communication in the context of this application may be referred to as near-field RF communication, near field RFID (Radio Frequency Identification) or near field communication. The range of such devices depends on the antenna used but may be, for example, up to 1 metre.

Communication of data between NFC communicators may be via an active communication mode in which the NFC communicator transmits or generates an alternating magnetic field modulated with the data to be communicated and the receiving NFC communicator responds by transmitting or generating its own modulated magnetic field, or via a passive communication mode in which one NFC communicator transmits or generates an alternating magnetic field and maintains that field and the responding NFC communicator modulates the magnetic field to which it is inductively coupled with the data to be communicated, for example by modulating the load on the inductive coupling (“load modulation”). Near field RF communicators may be actively powered, that is have an internal or associated power source, or passively powered, that is derive a power supply from a received magnetic field. Generally an RF transceiver will be actively powered while an RF transponder may be passively or actively powered.

Examples of near field RF communicators are defined in various standards for example ISO/IEC 18092 and ISO/IEC 21481 for NFC communicators, and ISO/IEC 14443 and ISO/IEC 15693 for near field RF communicators.

The technical apparatus used in the processing of retail transactions has remained essentially unchanged for many years. Typically, a mechanical or electronic register is used both to record the relevant data, and securely to store the currency used for payment. Systems such as cash registers, and EPOS systems, generally include a receipt printer which it operates to provide the customer with a record of the transaction.

Printing substrates for receipt printers are typically supplied in continuous sheets, which may be rolled. These receipt rolls, or till rolls, as they are often called come in a variety of formats and are used in a variety of different ways. Till rolls typically comprise paper, and are mostly used in the printers of point of sale (POS) systems such as cash registers, and in EPOS printers. There are a number of different types available, including (a) thermal till rolls and (b) two and three ply till rolls.

In thermal till rolls, one side of the paper has a special coating that is heat sensitive, to allow use in a thermal printer. These are perhaps the simplest, enabling a single copy to be produced quickly and cheaply without the need continually to restock the printer with ink for marking the paper. Two and three ply rolls may also be used, and are able to produce multiple copies of the printer output. This latter option is useful because often consumers desire a record of the relevant data, and there is also a need for the merchant to keep his or her own record.

The standard method of completing a transaction typically involves a POS system, where the consumer is presented with data indicating a required payment, and has to physically produce cash or credit/debit card details in order to provide payment. In the case of credit card or debit card the merchant then processes the transaction in order to receive payment. For example in a restaurant a consumer would request the bill from staff; the staff engage with a point-Of-Sale system (POS) to review the items ordered and print a paper bill on a printing substrate, such as thermal paper, using a thermal printer integrated in the POS system. This is then taken to the customer table to review. Cash or card payment is then accepted by the restaurant in order to settle the bill.

This method of completing transactions requires a staff member to process a transaction, using a POS, in order to receive payment. This can be time consuming and may lead to a backlog of transactions that need to be completed resulting in delays for the consumer, for example longer queue wait time, or a longer time to wait to settle a bill in a restaurant. Furthermore providing the required amount of POS devices and staff to operate them may be costly to a business, and in some cases impractical for example, where there is simply no space to provide another POS device.

US20090055280 and US20090055276 describe a computer program capable of receiving payments from multiple patrons while presenting the balance to them. US20180293562 presents a pay at table technology allowing customers to complete payment at the table while scanning a QR (quick response) code.

### SUMMARY

Embodiments of the present disclosure provide printing substrates, such as till rolls, and methods of manufacturing and using such substrates, which aim to improve efficiency of retail logistics at point of sale. Embodiments may reduce, or avoid, the need for adaptation of point of sale devices. As such additional capital outlay by the merchant and the unnecessary waste of resources (raw materials, and carbon footprint) associated with upgrading otherwise working hardware can also be reduced or avoided.

In an aspect there is provided a printing substrate for a printer of a point of sale system, the substrate comprising a printing surface for the printing of human readable information by the printer and at least one near field RF communicator, carried by the substrate, and configured to store an identifier to be communicated via near field communications to a near field communication device in near field range. The printing substrate may be arranged to provide a continuous feed to the printer, for example, it may be a till roll. In such a continuous feed arrangement, at least one the near field RF communicator may comprise a plurality of near field RF communicators, each disposed at regular intervals along the length of the substrate. The near field RF communicator may comprise a tag, such as an RFID tag, which may be a passive tag. The identifier may comprise a uniform resource locator (URL).

In an aspect there is provided a method comprising: (i) providing a printing substrate into a printer of a point of sale system, wherein the substrate comprises a printing surface for the printing of human readable information by the printer and carries at least one near field RF communicator storing an identifier for locating a remote data storage resource; (ii) printing human readable information by the printer on the printing substrate; (iii) using the unique identifier to write, to the remote data storage resource, computer readable data associated with the human readable information; and (iv) providing the printing substrate, printed with the human readable information, for reading by a near field RF communications enabled device, thereby to allow the near field RF communications enabled device to obtain the computer readable data from the remote data storage resource.

In an aspect there is provided a computer system comprising: a feed of printing substrate comprising a printing surface for the printing of human readable information by a printer of a point of sale system, a plurality of near field RF communicators and storing an identifier for locating a remote data storage resource wherein at least one near field RF communicator is associated with each region of the printing surface; a point of sale system comprising a printer for printing human readable information on the printing surface, and a first communications interface for communicating with the remote data storage resource; a data storage system, operable to communicate data with the point of sale system via the communications interface and comprising data storage resources each associated with one of a corresponding plurality of identifiers, and each operable to store machine readable data, wherein the point of sale system is configured to:
a) print human readable information on a region of the printing surface;
b) obtain the identifier of the at least one near field RF communicator associated with the region of the printing surface; and
c) provide, to the data storage system, data comprising the identifier and the computer readable data associated with the printed information, to cause the data storage system to store the computer readable data in a resource locatable using the at least one identifier.

It will be appreciated in the context of the present disclosure that typically, user equipment, such as cellular telephones, may be made and sold separately. This computer system however generally further comprises user equipment (a UE). Such a UE comprises near field RF communications functionality for reading an identifier from the at least one near field RF communicator, and being configured to: read the at least one near field communicator to obtain the at least one identifier; obtain, from the data storage resource associated with the at least one identifier, machine readable data; and display to a human user, human readable information based on the machine readable data for comparison with the printed information. The UE may be portable and carried by the user, freely to associate and dissociate from the system.

The point of sale system may be operated to read the near field RF communicator to obtain the identifier for use in providing (e.g. sending/writing) the computer readable data to the resource locatable using that identifier. A verification message comprising secure confirmation of a transaction corresponding to the unique identifier and the human readable information may be sent from a remote device, such as a device operated by a financial institution e.g. to confirm completion of the transaction to the point of sale device.

The printed human readable information generally occupies a length of the substrate, which may be determined by the content and length of the information. Thus the at least one near field RF communicator may comprise a plurality of near field RF communicators. For example, a number of tags may be included in a single receipt/bill. Each of these is associated with a respective corresponding one of a plurality of different identifiers for locating a remote data storage resource. In these embodiments, methods of the present disclosure comprise associating the human readable information with the plurality of different identifiers—so that any one of the plurality of identifiers can be used to retrieve the relevant data from the data storage resource. Associating the human readable information with the plurality of different identifiers may comprise writing the computer readable data to each of the remote data storage resources associated with the plurality of different identifiers.

The user equipment may be configured to perform said obtaining and displaying automatically in response to said reading. The display may include a verification trigger, operable by the user to initiate a financial transaction corresponding to the displayed human readable information. The verification trigger may comprise a user authentication means such as a password, biometric or other authentication means.

The point of sale device generally comprises a near field RF communications enabled device, and is configured to read the at least one near field communicator from the printing substrate to obtain the at least one identifier for providing the computer readable data to the resource.

The printing surface is typically a major surface of the printing substrate, and may carry a thermal dye. The thermal dye may be provided as a coating on the surface.

The thermal dye may comprise a heat-sensitive acid matrix layer and an acid sensitive dye. The receipt roll of claim 9, wherein the heat-sensitive acid comprises phosphonic acid, such as Octadecylphosphonic acid. The acid sensitive dye may comprise a leuco dye, such as crystal violet lactone. An encapsulation layer may be disposed on the thermal dye coating. The thermal dye may comprise Bisphenol S or Bisphenol A.

The at least one near field RF communicator may be connected to an antenna, which may be carried by the printing substrate. The antenna may be provided by a conductive ink, or other printable material, which may be printed on or integrated in the substrate. The antenna may comprise a conductive polymer, and/or a metal and/or a conductive carbon. The conductive carbon may comprise graphene.

The conductive ink may comprise a conductive filler. In one aspect of the present disclosure, a receipt has a substrate, a thermal dye assembly and one or more near field RF communicator. The substrate has two opposing major surfaces, where the thermal dye is coated on a first major surface and the one or more near filed communication tags are incorporated to a second major surface.

In another aspect of the present disclosure the receipt is produced by steps of: providing a roll of paper with opposite surfaces; using a roll to roll process to coat at least one surface with a thermal dye assembly; using a roll to roll process to print at least one antenna on at least one surface with conductive ink and attaching an integrated circuit (IC) to the substrate to complete a near field communicator. The roll-to-roll process in the aspect may be screen printing or gravure printing.

Embodiments of the disclosure may aim to provide customers with receipts which have embedded near-field communication antennas embedded within the receipt paper. In this way businesses, for example restaurants, do not have to substantially change any of their existing processes or hardware.

In one embodiment the invention relates to a receipt which comprises at least one near field RF communicator. In another embodiment the invention relates to a process to manufacture paper where at least one major surface carries at least one near field communicators and another major surface comprises a coating to facilitate printing on a standard restaurant thermal printer.

The computer system described herein may comprise a software (cloud-based) component, e.g. the data storage system and hardware components (such as the printed antennas). At the time of manufacture of the receipt roll, all near field communicators may be encoded with unique URLs.

Near field communication antennas may be made on a plastic substrate and by a lithographic process, which defines the pattern of the antenna, which is followed by metal deposition, typically aluminium, and then the bonding of the IC. Optionally, such near field communicators may be coated by an encapsulation layer on either side, or by an adhesive layer (e.g. Polyvinyl acetate) in order to make them into a sticker.

Near field communicators and near field communication antennas manufactured on other substrates, such as paper, may not require a lithographic process, like their plastic counterparts. Secondly, they may be printed directly in/on to a substrate where graphene may be used as the conductive filler which has lower cost than other materials such as Aluminium. Furthermore graphene, derived from graphite, is environmentally friendlier than aluminium or copper in such single use application. Thirdly, graphene offers superior flexibility under repeated bending, which is particularly preferable as receipt rolls are routinely tightly bound. Fourthly, graphene offers a more robust antenna material as it is insensitive to temperature oxidation, in contrast to aluminium which will oxidise by the heat in a thermal printer, which is detrimental in the performance of the near field communicator. Finally, since graphene is derived from graphite it offers a more economical material since it is cheaper than both copper and aluminium.

On the first day a restaurant, or other appropriate retail outlet starts to employ the systems and methods of the present disclosure, they can simply replace the roll of paper inside their thermal printer with a roll with (e.g. graphene) antennas and near-field RF communicators on one side, and thermal dye on the other. Upon clicking the first receipt in the point-of-sale (POS) system, the restaurant POS will communicate with the software cloud the following information: the table number, items ordered and bill total. The remote data storage system will then assign at least one of the URLs, e.g. A, to show the information it received from the ePOS.

In one aspect of the present disclosure, the receipt is printed and then taken to customer table. In order for the customer to pay, they: (1) wake up and unlock their phone (2) place the phone within <5 cm of the receipt which is programmed to (3) automatically launches a browser window, displaying the information sent from the POS, namely, the table number, the items ordered and the bill total. Finally, (4) The user is then invited to at least partially pay for the bill by tapping the pay button, confirming the total and optionally adding gratuity. Once the payment has been completed, a reconciliation request is sent back to the POS to close the table tab.

With reference to the drawings which will be discussed below, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

### BRIEF DESCRIPTION OF DRAWINGS

Embodiments of the disclosure will now be described, by way of example only, with reference to the accompanying drawing, in which:

FIG. 1 shows an example of the configuration of the thermal paper layers;

FIG. 2 shows an example of a receipt comprising a near field communicator;

FIG. 3 shows a process flow of completing a transaction according to embodiments of the present disclosure;

In the drawings like reference numerals are used to indicate like elements.

### SPECIFIC DESCRIPTION

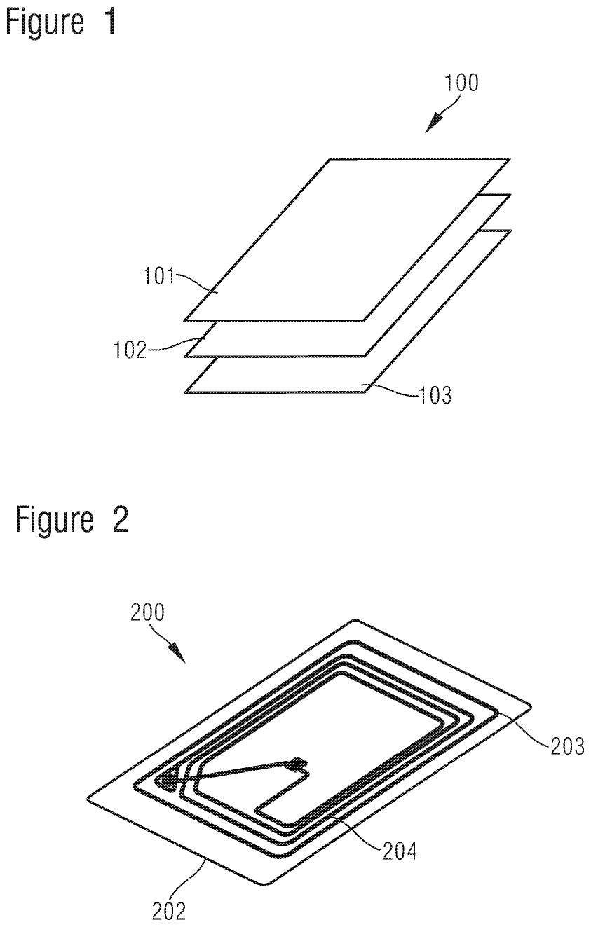

FIG. 1 shows a configuration used for thermal paper receipts. Typically a substrate 103, for example paper, is coated by a special thermochromic coatings or dyes 102. An optional top coating 101 may also be provided. These layers enable standard paper to become what is called thermal paper in the current art.

Thermal printers use heat to change the properties of this dye 102 within the paper 103 and change its colour from white to black. This allows the printer not to require ink or laser cartridges/toner which is unfavourable. The thermal printers are used to print the receipts which are then presented to the consumer.

FIG. 2 shows an embodiment of the present disclosure where a substrate 203 carries a near field RF communicator, the substrate is attached to a printing surface (e.g. a coating, and/or a thermochromic paper, to allow thermal printing). The substrate may comprise paper for integration into a structure such as that illustrated in FIG. 1, e.g. as is the paper (103; FIG. 1) in that construction. In this embodiment, at least one side of the substrate is coated with the thermochromic coatings or dyes 202, and as with the construction shown in FIG. 1, an optional top coating may also be provided to cover that coating. There can thus be provided a printing substrate (e.g. a thermal paper) suitable for use in a standard thermal printer, and which carries a near field RF communicator 204. This may be carried at a surface of the paper, or embedded within it. The structure illustrated in FIG. 2 may be provided in a continuous feed arrangement, for example in a receipt roll, to enable a selected length of the printing substrate to be used to print the human readable information which comprises a customer's bill or receipt. It will be appreciated in the context of the present disclosure that the near field RF communicators may be positioned at regular intervals, spaced apart along the length of the printing substrate. In this embodiment once these receipts go through a thermal printer in order to bill the receipt, for example for a table at a restaurant, the side comprising the thermal dye 202 will display the details of the bill.

Use of the construction shown in FIG. 2 will now be described with particular reference to a customer in a restaurant settling their bill, because this is a circumstance with which the reader is most likely to be familiar. However, it will be apparent on reading the present disclosure that this implementation is merely one example, and at a broader level, the present disclosure provides a secure and verifiable method of data verification. This can facilitate transactions with a merchant, but the present innovation resides primarily in the technical steps and considerations which support the streamlining of that procedure. These same technical steps and considerations may find application in other circumstances.

A data storage system, such as a server, may be provided which comprises a set of data storage resources—for example, this may comprise data storage (e.g. memory) accessible over the internet using a uniform resource locator (URL). This can provide a software (cloud-based) component. The near field RF communicators carried on the feed of printing substrate (e.g. the receipt roll) store data which encodes these URLs, which may be unique.

In use, the restaurant issues a bill using a point of sale system, which prints the bill detail in human readable form onto the printing substrate. It also obtains the identifier (e.g. the URL) carried by the near field communicator carried by the length of the printing substrate which forms that bill. This may be done by reading the near field RF communicator from the printing substrate, e.g. using a reader at the point of sale system. The POS can then send, to the data storage system, a data message comprising: the table number, items ordered and bill total.

This data is of course sent in machine readable form to enable the server to provide, at the URL associated with the identifier stored on the near field communicator carried by the receipt, a data resource which is accessible using that identifier to display human readable information on an item of user equipment, such as a smartphone, human readable information corresponding to the bill.

Once the receipt is printed, it is then taken to customer table. In order for the customer to pay, they: (1) wake up and unlock their phone (2) place the phone within <5 cm of the receipt. The smartphone may be configured to respond to the data encoded on the near field RF communicator by automatically launching a browser window, and formulating a request message (e.g. an HTTP request) to be sent to the URL associated with the identifier stored on the near field communicator. The browser then (3) displays the information sent from the POS, namely, the table number, the items ordered and the bill total.

Finally, (4) The user is then invited to at least partially pay for the bill by tapping the pay button, confirming the total and optionally adding gratuity. Once the payment has been completed, a reconciliation request is sent back to the POS to close the table tab. The payment process may be secured with a password or other secure authentication option, such as a biometric authentication.

Embodiments of the present disclosure may use a new generation of near field communicators, which may be manufactured directly integrated with a substrate, for example a paper receipt, and/or a thermal dye assembly to manufacture receipt rolls which can be used in thermal printers for example standard restaurant printers. The near field communicator may further comprise an antenna. In some embodiments the near field communicator and/or antenna comprise a flexible material, for example graphene, capable of withstanding repeated bending, such as the bending of a receipt roll. In another embodiment the near field communicator and/or antenna may comprise a material that has a high resistance to temperature oxidation, up to temperatures that may occur in a thermal printer. In some embodiments the antenna may be manufactured at the same time and in the same way as the near field communicator.

In some embodiments, conventional roll-to-roll or reel-to-reel printing processes can be used, for example flexo or gravure printing, can be used for the manufacture of the near field communicator and/or antenna. In another embodiment the conductive inks are directly deposited as a result of the above described roll-to-roll or reel-to-reel printing. In another embodiment conductive inks can be directly deposited on the paper substrate in an additive manufacturing manner. The inks may comprise a solvent, a dispersant and at least one conductive filler. Some embodiments the conductive filler comprises graphene where said graphene may or may not be derived from graphite. In another embodiment the near field communicator and/or antenna may be added to the substrate after it has been manufactured.

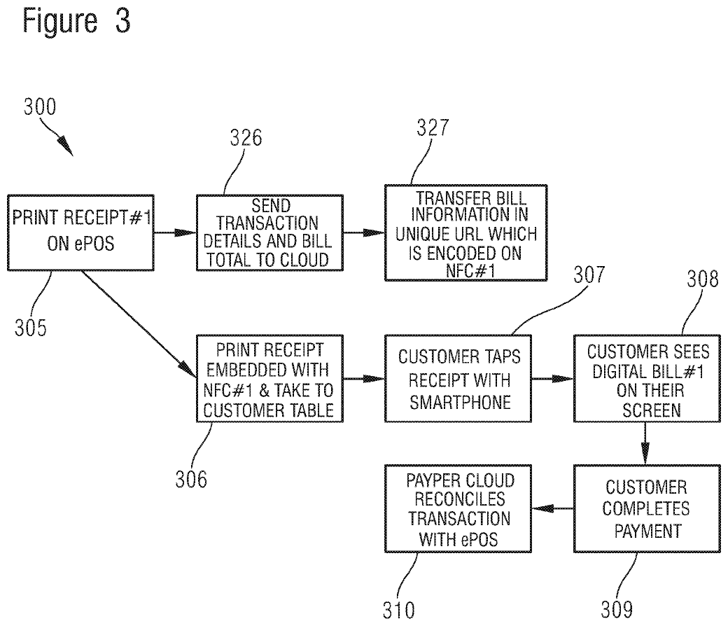

FIG. 3 shows an example flow chart of the steps that may occur in a restaurant using the receipt roll of the present invention. At step 305 a staff member will process the amount of money due from a customer on the POS and print the receipt.

The POS may then read the identifier (e.g. a URL) from the receipt, and send the details of the transaction 326 and the identifier to a data storage system such as a server.

In some embodiments step 326 involves sending multiple unique receipt identifiers to a server. In step 327 the server then sends the information to a unique URL corresponding to the unique receipt identifier such that when the customer brings their phone in to proximity with the receipt 307 they are able to see and pay for the bill on their phone. In some embodiments once payment has been received the server reconciles the transaction with the POS.

Embodiments of the present disclosure, when employed in a retail setting such sa a restaurant may provide a variety of benefits both to the consumers that use it to pay but also for the restaurants). These include: Reduced table turnover (customers checkout faster), reduced costs (no longer need to lease the card terminals) and importantly, and increased restaurant revenue.

The user equipment referred to herein has been described as a mobile telecommunications handset, but it will be appreciated in the context of the present disclosure that this encompasses any user equipment (UE) for communicating over a wide area network 50 and having the necessary data processing capability. It can be a hand-held telephone, a laptop computer equipped with a mobile broadband adapter, a tablet computer, a Bluetooth gateway, a specifically designed electronic communications apparatus, or any other device. It will be appreciated that such devices may be configured to determine their own location, for example using global positioning systems GPS devices and/or based on other methods such as using information from WLAN signals and telecommunications signals. The user device may comprise a computing device, such as a personal computer, or a handheld device such as a mobile (cellular) telephone or tablet. Wearable technology devices may also be used. Accordingly, the communication interface of the devices described herein may comprise any wired or wireless communication interface such as WI-FI®, Ethernet, or direct broadband internet connection, and/or a GSM, HSDPA, 3GPP, 4G or EDGE communication interface.

Messages and requests to receive, retrieve, or obtain data as described herein may comprise a data payload and an identifier (such as a URL uniform resource locator, or uniform resource indicator, URI) that identifies the resource upon which to apply the request. This may enable the message to be forwarded across a network to the device to which it is addressed. Some messages include a method token which indicates a method to be performed on the resource identified by the request. For example these methods may include the hypertext transfer protocol, HTTP, methods “GET” or “HEAD”. The requests for content may be provided in the form of hypertext transfer protocol, HTTP, requests, for example such as those specified in the Network Working Group Request for Comments: RFC 2616. As will be appreciated in the context of the present disclosure, whilst the HTTP protocol and its methods have been used to explain some features of the disclosure other internet protocols, and modifications of the standard HTTP protocol may also be used.

As described herein, network messages may include, for example, HTTP messages, HTTPS messages, Internet Message Access Protocol messages, Transmission Control Protocol messages, Internet Protocol messages, TCP/IP messages, File Transfer Protocol messages or any other suitable message type may be used.

The processors and the servers (e.g. data storage systems) described herein (and any of the activities and apparatus outlined herein) may be implemented with fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide the data storage resources of the server (and any of the apparatus) outlined herein.

It will be appreciated from the discussion above that the embodiments shown in the Figures are merely exemplary, and include features which may be generalised, removed or replaced as described herein and as set out in the claims.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

I claim:

1. A receipt roll for a receipt printer of a point of sale system, the receipt roll comprising:
a substrate for the printing of receipt information by the receipt printer;
and at least one near field RF communicator carried by the substrate and configured to store a unique identifier for communicating via near field communications to a near field communication device in near field range.

2. The receipt roll of claim 1, wherein the thermal dye is disposed on at least one major surface of the substrate.

3. The receipt roll of claim 1 or 2, wherein the at least one near field RF communicator further comprises an antenna.

4. The receipt roll of claim 3, wherein the antenna comprises a conductive carbon.

5. The receipt roll of claim 4, wherein the conductive carbon comprises graphene.

6. The receipt roll of any of claims 3 to 5, wherein the antenna comprises a conductive polymer.

7. The receipt roll of any of claims 3 to 6, wherein the antenna comprises a metal.

8. The receipt roll of any of claims 3 to 7, wherein the near field RF communicator antenna comprises conductive ink further comprising a conductive filler.

9. The receipt roll of claim 2 and any preceding claim dependent thereon, wherein the thermal dye coating comprises a heat-sensitive acid matrix layer and an acid sensitive dye, and/or wherein the thermal dye comprises Bisphenol S and/or Bisphenol A.

10. The receipt roll of claim 9, wherein the heat-sensitive acid comprises phosphonic acid, such as Octadecylphosphonic acid.

11. The receipt roll any one of claim 9 or 10, wherein the acid sensitive dye comprises a leuco dye, such as crystal violet lactone

12. The receipt roll of any of claims 9 to 11, further comprising an encapsulation layer disposed on the thermal dye coating.

13. A method comprising:
(i) providing a printing substrate into a printer of a point of sale system, wherein the substrate comprises a printing surface for the printing of human readable information by the printer and carries at least one near field RF communicator storing an identifier for locating a remote data storage resource;
(ii) printing human readable information by the printer on the printing substrate;
(iii) using the unique identifier to write, to the remote data storage resource, computer readable data associated with the human readable information; and
(iv) providing the printing substrate, printed with the human readable information, for reading by a near field RF communications enabled device, thereby to allow the near field RF communications enabled device to obtain the computer readable data from the remote data storage resource.

14. The method of claim 13 comprising operating the point of sale system to read the near field RF communicator to obtain the unique identifier for performing the writing.

15. The method of claim 13 or 14 comprising receiving, from a remote device, a verification message comprising secure confirmation of a transaction corresponding to the unique identifier and the human readable information.

16. The method of any of claims 13 to 15, wherein the printed human readable information occupies a length of the substrate, and the at least one near field RF communicator comprises a plurality of near field RF communicators each associated with a respective corresponding one of a plurality of different identifiers for locating a remote data storage resource, the method comprising associating the human readable information with the plurality of different identifiers.

17. The method of claim 16 wherein associating the human readable information with the plurality of different identifiers comprises writing the computer readable data to the remote data storage resources associated with the plurality of different identifiers.

18. A computer system comprising:
a feed of printing substrate comprising a printing surface for the printing of human readable information by a printer of a point of sale system, a plurality of near field RF communicators and storing an identifier for locating a remote data storage resource wherein at least one near field RF communicator is associated with each region of the printing surface;
a point of sale system comprising a printer for printing human readable information on the printing surface, and a first communications interface for communicating with the remote data storage resource;
a data storage system, operable to communicate data with the point of sale system via the communications interface and comprising data storage resources each associated with one of a corresponding plurality of identifiers, and each operable to store machine readable data, wherein the point of sale system is configured to:
print human readable information on a region of the printing surface;
obtain the identifier of the at least one near field RF communicator associated with the region of the printing surface; and
provide, to the data storage system, data comprising the identifier and the computer readable data associated with the printed information to cause the data storage system to store the computer readable data in a resource locatable using the at least one identifier;
the computer system further comprising user equipment comprising near field RF communications functionality for reading an identifier from the at least one near field RF communicator, and being configured to:
read the at least one near field communicator to obtain the at least one identifier;
obtain, from the data storage resource associated with the at least one identifier, machine readable data;
display to a human user, human readable information based on the machine readable data for comparison with the printed information.

19. The system of claim 18, wherein the user equipment is configured to perform said obtaining and displaying automatically in response to said reading.

20. The system of claim 19, wherein the display includes a verification trigger, operable by the user to initiate a financial transaction corresponding to the displayed human readable information.

21. The system of claim 18 or 19 wherein the point of sale device comprises a near field RF communications enabled device, and is configured to read the at least one near field communicator to obtain the at least one identifier for providing the computer readable data to the resource.

22. A method of providing a printable medium for use in a receipt printer of a point of sale system, the method comprising:
(i) providing a substrate with a first and second surface;
(ii) using a roll to roll process to coat the first surface with a thermal dye;
(iii) using a roll to roll process to print at least one antenna on at least one surface of the substrate; and
(iv) attaching a near field RF communicator to the at least one antenna.

23. The method of claim 22 wherein in the step using a roll to roll process to print at least one antenna on the at least one surface includes using one of flexography or gravure printing.

24. A method of displaying details of an invoice on a mobile device comprising the steps:
assigning a receipt from a receipt roll corresponding to a transaction, the receipt comprising a first surface for displaying the details of said transaction and a second surface, wherein the receipt further comprises a near field communicator tag, the near field communicator tag further comprising a unique URL address;
displaying the details of said transaction on a web page associated to said unique URL address;
printing the receipt and bringing the receipt into proximity of the mobile device connectable to the internet such that the near field communicator tag transmits a signal to said mobile device instructing said mobile device to open a browser and go to said web page associated to said unique URL address stored on the near field communicator tag, wherein said web page displays the details of said transaction.

25. A point of sale system comprising a receipt printer, and means for reading a near field RF communicator to obtain a unique identifier, wherein the receipt printer is configured to print human readable text on to a receipt comprising the near field communicator, and the system is configured to read the unique identifier from the near field RF communicator and to provide information corresponding to the human readable text to a remote communications device for storage and retrieval, whereby the information is accessible from the device using the unique identifier.
